(19) United States
(12) Patent Application Publication
(10) Pub. No.: US 2020/0005609 A1
(43) Pub. Date: Jan. 2, 2020

(54) A LIGHTING ENABLED SYSTEM AND METHODS FOR BUILDING EVACUATION PLANNING

(71) Applicant: SIGNIFY HOLDING B.V., EINDHOVEN (NL)

(72) Inventors: ABHISHEK MURHTY, ARLINGTON, MA (US); ROHIT KUMAR, HACKENSACK, NJ (US); TAMIR HEGAZY, WINCHESTER, MA (US)

(21) Appl. No.: 16/482,370

(22) PCT Filed: Jan. 29, 2018
(86) PCT No.: PCT/EP2018/052044

§ 371 Date: Jul. 31, 2019

Related U.S. Application Data
(60) Provisional application No. 62/453,601, filed on Feb. 2, 2017.

(30) Foreign Application Priority Data
Feb. 23, 2017 (EP) 17157652.3

(51) Int. Cl. G08B 7/06; G06Q 10/06; F24F 11/30; H05B 37/02; G01C 21/20

(52) U.S. Cl. CPC G08B 7/066; G06Q 10/06; G01C 21/206; H05B 37/0272; H05B 37/0218; F24F 11/30

(57) ABSTRACT

Disclosed are a system and method for developing computational models of the behavior of a building's occupants using data acquired from sensor-equipped connected luminaires. The models are then used to develop an optimized evacuation plan for safe and timely egress of the occupants without requiring mock evaluation drills.

### FIELD OF THE INVENTION

The present invention is directed to a system and method for developing computational models of the behavior of a building's occupants using data acquired from sensor-equipped connected luminaires. The models are then used to plan and design evacuation plans for safe and timely egress of the occupants.

### BACKGROUND OF THE INVENTION

Large buildings, such as office spaces and residential high rises, in cities periodically undergo mock evacuations to inspect the validity of an evacuation plan and the readiness of the occupants to execute the plan. These mock drills are expensive in terms of the total man-hours lost in the drills, as well as inconvenient to the occupants of the buildings. Moreover, the evacuation plans are typically designed before the occupants move into the building, and are therefore agnostic of actual occupant dynamics. Flexible office spaces, which dynamically manage the workspaces based on demand, and events in the buildings like conferences and workshops, can lead to significant variability in the occupant dynamics and thereby invalidate the evacuation plan. As buildings evolve to be evermore dynamic spaces, rapid and effective evacuation will continue to be a pertinent problem.

The present invention addresses the above problems by providing a system and method that aids the design and verification of evacuation plans while alleviating the dependence on mock drills. In one aspect of the invention, building-wide sensor-enabled connected lighting and data-driven methods are employed to automate the process of exhaustively verifying the evacuation plan of a building. Moreover, the proposed system can also be used to design an evacuation plan based on the recent history of building dynamics.

The present invention focuses on the following two aspects of building evacuation, but can be extended to other aspects also: Timeliness and Safety. Timeliness dictates that the occupants must be able to exit the building within the specified time bound. Safety entails ensuring that critical areas of the region do not get overcrowded and lead to injuries caused by other fleeing occupants.

In accordance with the principles of the invention, occupancy and motion sensors are present on a connected lighting system. Such systems are known in the prior art. By way of example, the lighting network systems described in U.S. Pat. No. 8,970,365 entitled “Evacuation System,” and in International Publication Number WO 2014/080040A2, entitled “Method and System for Evacuation Support;” both of which are hereby incorporated by reference in their entirety.

### SUMMARY OF THE INVENTION

In the present invention the lighting system is used to collect fine-grained data about mobility of people. This data is then used to learn models of occupancy and motion among different rooms. System identification is used to learn these models. The models are then transformed to computational models that are amenable to formal verification-based analytics. Formal verification is the process of exhaustively and automatically analyzing the trajectories of a model of the underlying system. In safety-critical applications, such as defense and aerospace, and mission-critical applications, such as chip manufacturing, formal verification has successfully been used to guarantee the safety of large complex systems. The exhaustive nature of analysis ensures that guarantees can be given on the safety and timeliness of the evacuation plan.

In accordance with another aspect of the invention, the proposed system can be used to design and synthesize an evacuation plan on-the-fly. Consequently, the system would adapt to the changing occupancy patterns and dynamically generate correct-by-construction evacuation plans. These evacuation plans can be used to actuate the lights of the building in patterns that guide the people, like the emergency lights of an airplane.

Various embodiments of the invention attain the following beneficial benefits with respect to building evacuation issues:

Reduces any dependency on expensive and time-consuming mock drills, which can cause inconvenience to the building occupants,

Can work on-the fly to provide that the evacuation plan can guarantee timely and safe evacuation of the building despite dynamically changing occupancy patterns.

Can aid the fire department officials with the inspection of large buildings, and

Aid decision making for experts that plan for contingencies in large buildings.

As used herein:

The term “Luminaire” or “lighting fixture” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources, alone or in combination with other non LED-based light sources.

The term “light source” should be understood to refer to any one or more of a variety of radiation sources, including, but not limited to, LED-based sources (e.g., various semiconductor-based structures that emit light in response to current, light emitting polymers, organic light emitting diodes (OLEDs), electroluminescent strips, and the like), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radio luminescent sources, and luminescent polymers.

The term “controller” is used herein generally to describe various apparatus relating to the operation of one or more Luminaires. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communication medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g. for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates the main elements of an embodiment of the current invention.

FIG. 2 illustrates a flow chart of an exemplary model-based building evacuation planning according to an embodiment of the invention.

FIG. 3 illustrates is an exemplary modeling of the occupancy and mobility in a room with two occupancy sensors.

FIG. 4 illustrates a compartmental model for the room illustrated in FIG. 3.

### DETAILED DESCRIPTION OF THE EMBODIMENTS

It is to be understood that the figures and descriptions of the present invention described herein have been simplified to illustrate the elements that are relevant for a clear understanding of the present invention, while eliminating, for purposes of clarity only, many other elements. However, because these eliminated elements are well-known in the art, and because they do not facilitate a better understanding of the present invention, a discussion of such elements or the depiction of such elements is not provided herein. The disclosure herein is directed also to variations and modifications known to those skilled in the art.

It will be further understood that the present invention is described with regard to a specific implementation of a lighting system requiring light sources and luminaries. In the specific field of light management, occupancy sensors are sensing devices commonly connected to a room's lighting, which shut down these services when the space is unoccupied. However, it would be appreciated that other types of sensor devices can be employed without altering the scope of the invention.

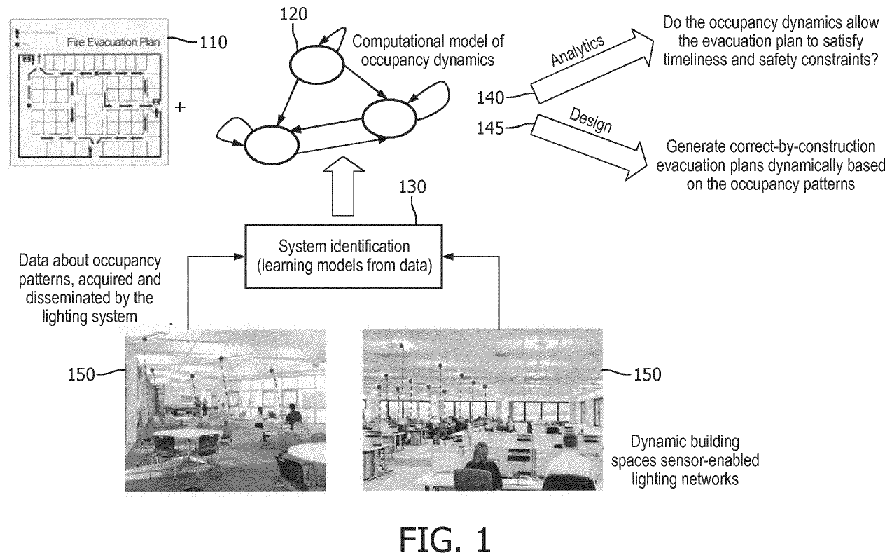

FIG. 1 illustrates an embodiment of the invention. In particular, the figure depicts the following elements of an exemplary system:

Item 150. Building rooms that are equipped with an intelligent lighting system that detects occupancy in different parts of the building, can count people, and aid the modelling (Item 130) of the dynamics of the occupants' movements. In various embodiments of the invention the exact locations of each of the system's luminaire sensors (positioned throughout office rooms, hallways, bathrooms, etc.) is determined and recorded in a database upon commissioning of the system's luminaires. Such commissioning procedures are well-known in the prior art (e.g., as described in U.S. Pat. Appln. No. 20160205749 entitled “LIGHTING COMMISSIONING).

Item 110. The emergency evacuation plan of the region of the interest. This region can be a part of the floor, the entire floor, or even the entire building.

Item 120. A modelling engine that builds models of occupants moving in the building. System identification is used by this engine to estimate the models.

Item 140. A Verification-Based Analytics Engine (VBAE), which uses formal verification to analyze the models of building dynamics.

Item 145. In a further embodiment, the proposed system can be used to design and synthesize an evacuation plan on-the-fly. Consequently, the system would adapt to the changing occupancy patterns and dynamically generate correct-by-construction evacuation plans. These evacuation plans can be used to actuate the lights of the building in patterns that guide the people, like the emergency lights of an airplane.

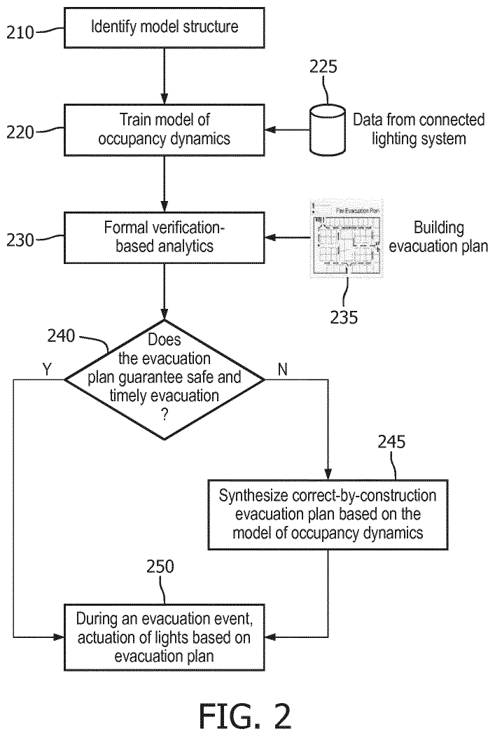

FIG. 2 illustrates a flow chart for an exemplary model-based building. Step 210 is a preliminary step during which is entered the most appropriate type of model for the given building—and thus the overall context in which the system operates. The example discussed below is one embodiment that entails using compartmental models, which is ideal for large buildings. Simpler models, like cellular automata, may be employed for small buildings such as homes. Item 225 depicts a data base of fine-grained data about the mobility of building occupants. This data has been collect using occupancy and motion sensors present on a connected lighting systems as discussed above (e.g., with respect to items 150 of FIG. 1). At step 220 this data is used to learn models of occupancy and motion among different rooms. System identification is used to learn these models.

At step 230 the models are transformed to computational models that are amenable to formal verification-based analytics. These models are employed in step 240 to evaluate the current evacuation plan (item 235). In various embodiments of the invention, such evaluations occur periodically and/or when triggered by events. An example of the modelling process will now be provided: Let the model of occupant dynamics for floor i under the evacuation plan, be denoted by [symbol] ᵢ; and the dynamics of moving from floor i to floor j be denoted by [symbol] ᵢⱼ. The dynamics for the entire building of N floors can be obtained by composing the models:

[symbol]

= [symbol] _{N}× [symbol] _{NN-1}× [symbol] _{N-1}× . . . [symbol] ₁× [symbol] ₁₀, where × denotes the composition operator.

Formal verification is then performed. Formal verification is the process of exhaustively and automatically analyzing the trajectories of a model of the underlying system. In safety-critical applications, such as defense and aerospace, and mission-critical applications, such as chip manufacturing, formal verification has successfully been used to guarantee the safety of large complex systems.

As timeliness and safety are important concerns of the present invention, these features are addressed in the modelling and verification process. In particular, timeliness and safety concerns are encoded in Temporal Logic Formulae. Temporal logic is the language of formal verification. Specifically, bounded-time temporal logic can be used to specify the timeliness and safety properties of building evacuation.

For example: Consider the timeliness requirement for the evacuation of a building of N floors: Floor i must be evacuated within time tᵢ for 1≤i≤N. This can be expressed as a bounded-time temporal logic formula:

ψₜᵢₘₑₗᵢₙₑₛₛ=Evac₁^{t}^{₁}∧Evac₂^{t}^{₂}∧Evacᵢ^{t}^{ᵢ}∧ . . . Evac_{N}^{t}^{_{N}}.

Similarly, the safety requirements ψ_{safety} can also be encoded in temporal logic.

Once the requirements are established, formal verification can be used to answer the following question:

[symbol]

[symbol]

ψₜᵢₘₑₗᵢₙₑₛₛ∧ψ_{safety}?

In other words, does the model M satisfy the timeliness and safety requirements? The research community has developed several algorithms to answer this question by reasoning exhaustively about the trajectories of [symbol] . One such prior art example of this technique is discussed in U.S. Pat. Appln. No. 2016/0262307 entitled “TEMPORAL LOGIC ROBUSTNESS GUIDED TESTING FOR CYBER-PHYSICAL SYSTEMS.” Consequently, guarantees can be given on the evacuation plans based on the assumptions of the model [symbol] .

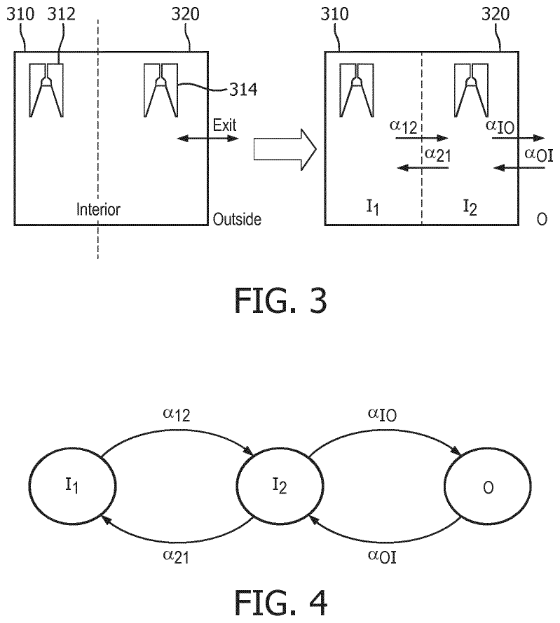

As an aide to understanding, a simple example will now be provided in which there exists a room with one exit and two sensor-equipped luminaires (312, 314), as depicted in FIG. 3. As illustrated, the interior of the room can be divided into two parts (310, 320). Letting I₁, I₂, and O denote the proportion of the occupants that are in the interior partitions and outside the room. The rates of transitioning among these partitions are α₁₂, α₂₁ between the 310 and 320 regions; and α_{IO}, α_{OI} between the interior and outside, via the 320 region. Note that the proportions and the transfer rates can be estimated using the data from the luminaire-based sensors. As used herein “system identification” entails learning the transfer rates and other parameters using the sensor data. Inverse modeling techniques, including optimization, may be used to update the parameters periodically.

Once these estimates are determined, a compartmental model, as depicted in FIG. 4, can be constructed. This model describes how the proportions of occupants in the three regions evolve in time with respect to the following formulae:

$$\begin{matrix}\frac{d {I}_{1}}{d t} = {α}_{21} {I}_{2} - {α}_{12} {I}_{1} & ( 1 ) \\ \frac{d {I}_{2}}{d t} = {α}_{12} {I}_{1} + {α}_{OI} O - ( {α}_{21} + {α}_{IO} ) {I}_{2} & ( 2 ) \\ \frac{dO}{d t} = {α}_{IO} {I}_{2} - {α}_{OI} O & ( 3 )\end{matrix}$$

We can then evaluate an evacuation plan (which can be constructed from the evacuation plan of the floor) which states: “If in 310, then move to 320. If in 320, move to O.”

Formal verification considers the behaviors of the quantities I₁, I₂, and O under the evacuation plan, as governed by the equations (1)-(3). The timely evacuation requirement can be stated as: “Ensure that both I₁ and I₂ go to 0 and O goes to 1 within time T₁”. The temporal logic representation of this would be:

ψ_{timely}=ψ₁∧ψ₂∧ψ₃,

where ψ₁=(I₁=0)_{≤T}_{₁}, ψ₂=(I₂=0)_{≤T}_{₁} and ψ₃=(O=1)_{≤T}_{₁}

The safe evacuation requirement can be stated as: “Ensure that people are not moving too fast between different parts of the building to prevent stampedes.” In other words, ensure that the rate of change of I₁, I₂, and O are bounded by θ. The temporal logic representation of this would be:

$${ψ}_{safety} = {ψ}_{4} {ψ}_{5} {ψ}_{6} , \\ where {ψ}_{4} = \frac{d {I}_{1}}{d t} \leq θ , {ψ}_{5} = \frac{d {I}_{2}}{d t} \leq θ , {ψ}_{6} = \frac{d O}{d t} \leq θ$$

Returning to FIG. 2, at step 240, if the verification process determines that such a guarantee exists, the method proceeds to step 250. Alternatively, at step 245 the plan is corrected until the guarantee is attained, at which point the process proceeds to step 250. In particular, step 245 entails controller synthesis: given a behavior that is wanted to be induced in the system, controller synthesis entails designing a control law that ensures that the system conforms to the requirements. The evacuation plan is considered to be a controller that controls the occupancy of different partitions of the region of interest. The occupants are guided to move among the partitions during an evacuation, thereby controlling the occupancy. If the current evacuation plan is deemed to be unsafe or too slow, then the plan is modified such that safety and timeliness requirements are met by the new model. Controller synthesis algorithms enable the automatic computation of the corrections to be made to the plan. In alternative embodiments of the invention in which no current evacuation plan exists, then step 245 relates to designing a safe and timely occupancy plan based on the occupancy and mobility model. It should be noted that in each of these embodiments, the resulting plan is attained without requiring any data attained from mock evacuation drills.

An optional step is depicted at step 250, wherein the process would, in the event of an evacuation event, activate exit light signaling based on the determined evacuation plan.

In summary in designing and synthesizing the evacuation plan, a control-theoretic approach is adopted. The dynamics of the people are considered as the plant and the evacuation process as the control input. The evacuation plan design problem then becomes an instance of controller design. In obtaining this evacuation plan design, a formal verification procedure is performed to optimize the evacuation plan in light of the dynamics of the occupants.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although, a computer, a processor and/or dedicated hardware/software are described herein as being capable of processing the processing described herein, it would be recognized that a computer, a processor and/or dedicated hardware/software are well-known elements in the art of signal processing and, thus, a detailed description of the elements of the processor need not provided in order for one skilled in the art to practice the invention described, herein.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage.

The term “comprises”, “comprising”, “includes”, “including”, “as”, “having”, or any other variation thereof, are intended to cover non-exclusive inclusions. For example, a process, method, article or apparatus that comprises a list of elements is not necessarily limited to only those elements but may include other elements not expressly listed or inherent to such process, method, article, or apparatus. In addition, unless expressly stated to the contrary, the term “or” refers to an inclusive “or” and not to an exclusive “or”. For example, a condition A or B is satisfied by any one of the following: A is true (or present) and B is false (or not present); A is false (or not present) and B is true (or present); and both A and B are true (or present).

While there has been shown, described, and pointed out fundamental and novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention.

It is expressly intended that all combinations of those elements that perform substantially the same function in substantially the same way to achieve the same results are within the scope of the invention. Substitutions of elements from one described embodiment to another are also fully intended and contemplated.

Any reference signs in the claims should not be construed as limiting the scope of the claims or the invention described by the subject matter claimed.

1. A system for evaluating evacuation plans for occupants of a building, the system comprising:
a plurality of luminaires and a plurality of sensors each plurality being installed at locations throughout the building, at least some of the plurality of sensors in communication with at least one luminaire, wherein each of said plurality of luminaires being configured to communicate with at least one other luminaire to form a network, wherein the networked luminaires form a unified sensor network;
a processor configured to receive an evacuation plan for the building, collect sensor occupancy/motion data from the plurality of sensors prior to an evacuation event, model the occupants' movements between different parts of said building using the sensor occupancy/motion data, wherein the model includes determining a transfer rate of occupants' movements between different parts of said building, and use the models to modify the evacuation plan if the transfer rate is to fast or slow based on a predetermined criteria.

2. The system of claim 1 wherein at least some of the sensors are co-located with one of the plurality of luminaires.

3. The system of claim 2 wherein the location of each of the sensors that is co-located with a luminaire is determined upon commissioning of the luminaire.

4. The system of claim 1 being further configured to develop an optimized evacuation plan that seeks to optimize the safe and timely egress of the building's occupants, wherein said optimized plan is determined without requiring any information attained by one or more mock evacuation drills.

5. The system of claim 4 wherein said processor is further configured to evaluate an evacuation plan using both timeliness and safety criteria.

6. The system of claim 5 wherein the evaluation is performed and an optimal evacuation plan determined by using a formal verification algorithm which employs a bounded-time temporal logic formula.

7. The system of claim 6 wherein the determination of an optimal evacuation plan is performed on-the-fly to reflect changes in occupants' movements between said different parts of the building.

8. The system of claim 7 further comprising lights that upon a need for a building evacuation, invoke the optimal evacuation plan by conveying one or more routing paths for egress of the occupants.

9. The system of claim 8 being further configured to determine the occupation status of parts of the building after an actual evacuation has occurred.

10. A method for operating a system of networked sensor equipped lights installed in a building to develop an evacuation plan for one or more parts of the building, the method comprising:
receiving an evacuation plan for the building;
detecting the presence of occupants in different parts of the building;
collecting sensor occupancy/motion data from the plurality of sensors prior to an evacuation event;
modelling occupants' movements between said different parts of said building using the sensor occupancy/motion data;
determining a transfer rate of occupants' movements between different parts of said building using the model from the modelling step;
modifying the evacuation plan if the transfer rate is to fast or slow based on a predetermined criteria.

11. The method of claim 10 wherein said evaluating step comprises developing an evacuation plan that seeks to optimize the safe and timely egress of the occupants.

12. The method of claim 11 wherein said developing step comprises using a formal verification algorithm which employs a bounded-time temporal logic formula.

13. The method of claim 12 wherein said developing step is performed on-the-fly to reflect changes in occupants' movements between said different parts of the building.

14. The method of claim 13 wherein upon determination of a need to evacuate the building, utilizing one or more of the lights to provide guidance to the occupants in their exiting of the building.

15. A computer-readable, non-transitory medium having stored therein instructions for causing a processing unit to execute a method for operating a system of networked sensor equipped lights installed in a building to develop an evacuation plan for one or more parts of the building, the medium comprising code for:
receiving an evacuation plan for the building;
receiving sensor occupancy/motion data regarding the presence of occupants in different parts of the building from a plurality of sensors prior to an evacuation event;
modelling occupants' movements between said different parts;
developing an optimized evacuation plan for the occupants based on the results of said modelling step.
